(19) United States
(12) Patent Application Publication
(10) Pub. No.: US 2004/0132912 A1
(43) Pub. Date: Jul. 8, 2004

(54) Open air surface cure of elastomers

(76) Inventor: Clay B. McElwee, West Chester, PA (US)

Correspondence Address: COZEN O'CONNOR, P.C., 1900 MARKET STREET, PHILADELPHIA, PA, 19103-3508, US

(21) Appl. No.: 10/625,283

(22) Filed: Jul. 23, 2003

Related U.S. Application Data
(60) Provisional application No. 60/438,548, filed on Jan. 6, 2003.

(51) Int. Cl. C08F 8/00

(52) U.S. Cl. 525/326.1; 525/326.2; 525/326.5; 525/329.1; 525/330.3; 525/331.7

(57) ABSTRACT

An organic peroxide vulcanized elastomer having a tack free or low tack surface is prepared under open surface conditions by curing a composition comprising a solid elastomer, an organic peroxide initiator, and a metal carboxylate. The metal carboxylate may be dissolved in a cross-linking coagent and then blended with the elastomer prior to open surface curing. Examples of the open surface molding methods include hot air, steam, salt bath, and sand bath.

### CROSS REFERENCE TO RELATED APPLICATIONS

Benefit of Provisional Application 60/438,548 filed Jan. 6, 2003 is claimed

### BACKGROUND OF THE INVENTION

This invention relates to curing methods for elastomers and to the compositions and articles prepared by such methods.

Elastomers can be vulcanized in a number of ways, for example with sulfur compounds or with organic peroxides. Sulfur vulcanization has the advantage of not being inhibited by oxygen at the surface of the article being molded, whereas organic peroxide cure methods have been limited to closed pressure molding (such as compression, transfer, and injection molding) because it is generally understood in the art that oxygen contacting the surface during molding reacts with the peroxy catalyst to cause hydroperoxy radicals which inhibit vulcanization and cause degradation of the resultant polymer. This results in tacky and/or partially cured elastomer surfaces. This is due to radicals in the polymer chain coupling with free oxygen to create hydroperoxy radicals. This hydroperoxy radical inhibits vulcanization and ultimately leads to degradation of the polymer. This phenomenon normally limits the production of peroxide-cured elastomers to molded goods. The three main types of molding are compression, transfer, and injection molding processes. All of these molding methods rely on an enclosed cavity for curing, and pressure to keep oxygen out of the system.

Typical cure mechanisms associated with sulfur vulcanization of elastomers are not normally inhibited by the presence of oxygen. This allows such sulfur cured elastomers to be cured in a wide variety of open surface methods in addition to the closed compression, transfer, and injection molding methods. Such open surface methods by which sulfur curing but not peroxide curing were practical in the prior art include: Open Hot Air Environment; Open Steam Environment; Open Salt Bath; and Open Sand Bath.

Although it is theoretically possible to peroxide-cure elastomers in an open-air environment by removing the oxygen from the curing environment by purging with nitrogen or another suitable material, such a method is unrealistic in commercial elastomer production since the curing environment is too large and would require an uneconomical supply of nitrogen to purge the cure area.

### SUMMARY

It has been discovered that an organic peroxide-initiated elastomer composition comprising a metal carboxylate can be molded under open surface conditions to produce a tack free or low tack surface molding. The invention comprises the method of molding, the molding composition, the molding produced by the process, and molded articles prepared by the process.

### DETAILED DESCRIPTION

Elastomers to which the invention is applicable are any which can be molded under open surface conditions using organic peroxide initiators. Examples of such elastomers include ethylene-propylene diene rubber (EPDM), nitrile rubber (NBR), polychloroprene (CR), hydrogenated NBR (HNBR), styrene-butadiene rubber (SBR), polybutadiene rubber (BR), ethylene-propylene copolymer (EPM), fluoroelastomers (FKM), silicone rubber (MQ, VMQ), acrylic rubber (ACM), Acrylonitrile-butadiene-styrene (ABS), polyethylene (PE), chlorosulfonated polyethylene (CSM), chlorinated polyethylene (CM) (also known as CPE), natural polyisoprene (NR), synthetic polyisoprene (IR), and ethylene-vinyl acetate (EVA). EPDM is the most typical elastomer presently used in this art.

Suitable organic peroxides are any of the ones which are used in the art of curing the elastomers. Examples include dicumyl peroxide, di-(t-butylperoxy)-diisopropylbenzene, 2, 5 dimethyl-2,5-di-(t-butyl-peroxy) hexane (DBPH), 2,5-dimethyl-2,5-Di-(t-butyl-peroxy)hexyne-3 (Varox 130 type), n-Butyl 4,4-Di(t-butylperoxy) valerate (Varox 230 type), and 1,1 bis-(t-butylperoxy)-3,3,5-trimethyl-cyclohexane (Varox 231 type).

The amounts of peroxide are also any of the amounts used in the art of peroxide-cured molding elastomers, usually about 0.1 to 10 percent, based on elastomer.

The composition can also include any cross-linking coagent. Some examples include trimethylol propane trimethacrylate (TMPTM), trimethylol propane triacrylate, triallyl cyanurate, bis maleimide, 1,2-vinyl polybutadiene; and the like.

The metal carboxylate is added by any means. Some examples include combining the carboxylate with the elastomer by conventional blending or pre-dissolving in a cross-linking coagent (typically in a concentration of about 5 to 25% by weight), and then adding the solution to the elastomer, for example in a ratio of about 2 to 20 parts by weight of the solution per 100 parts by weight of the elastomer.

Typical amounts of metal carboxylate compound are 0.1 to 10 parts by weight per hundred overall elastomer, peroxide, and metal carboxylate composition. Preferably 0.2 to 2.5 parts by weight of the metal carboxylate is used.

The metal compound can be any metal carboxylate, preferably C₂ to C₂₀ fatty acid, for example metal neodecanoate, metal proprionate, metal naptheneate, and/or metal octoate.

Suitable metals include, for example, cobalt, zirconium, manganese, zinc, iron, aluminum, and tin. Cobalt is the most preferred metal, and cobalt neodecanoate is the most preferred metal carboxylate. Mixtures of metal carboxylates are also suitable.

The curing conditions are any of those used in open surface molding of elastomers, for example open hot air, open steam, open salt bath, and open sand bath methods. While the novel compositions of the invention can be used in any molding method, the advantage of low tack to tack-free surfaces is an improvement most particularly applicable to open molding methods.

While not intending to be limited to any theory of operation, it is believed that incorporation of the metal compound in the peroxide-initiated elastomer formulation prevents oxygen from degrading the peroxy radicals on the elastomer surface.

### EXAMPLES

In the following examples, all parts and percentages are by weight, unless otherwise indicated.

### Example 1 (Comparative)

A formulation consisting of 100 parts EPDM elastomer (Dupont-Dow IP 4640 brand) was blended with 7.5 parts Dicumyl peroxide (Hercules DiCup 40 KE brand) and 5 parts Trimethylolpropane trimethacrylate (Sartomer SR 350 brand). The composition was mixed and molded under open air cure conditions at 330° F. for 40 minutes and press cured for 45 minutes at 330° F. The following properties were measured: degree of tack on cured plaques, tensile strength, elongation, and modulus. The results are reported in the table below.

### Examples 2 and 3 (Invention)

Example 1 was repeated except using 0.25 parts cobalt neodecanoate in Ex. 2 and 0.5 parts in Ex. 3, with the results reported in the table below.

As can be seen from the results of the comparative testing, the moldings of the invention had no tack on their surfaces whereas the molding of the comparative example had a tacky surface.

| | TABLE | | |
|---|---|---|---|
| | EXAMPLE | | |
| | 1 | 2 | 3 |
| Formulation | | | |
| EPDM¹ | 100 | 100 | 100 |
| Dicumyl peroxide² | 7.5 | 7.5 | 7.5 |
| Trimethylolpropane | 5 | 4.75 | 4.5 |
| trimethacrylate³ | | | |
| Cobalt Neodecanoate | | 0.25 | 0.5 |
| Mixing | | | |
| Cure Meter; ASTM D2084 | | | |
| ODR, 320° F. | | | |
| MH, in-lb | 97.6 | 103.6 | 107.3 |
| ML, in-lb | 11.6 | 11.7 | 11.8 |
| MH - ML, in-lb | 86 | 91.9 | 95.5 |
| Tc90, min | 33.7 | 34.3 | 33.2 |
| Ts2, min | 1.25 | 1.27 | 1.26 |
| Degree of flash tack | tacky | no tack | no tack |
| Plaques molded but not cured in carver | | | |
| press for 5 minutes @ 212° F. | | | |
| Open Air Cure @ 330° F. (min) | 40 | 40 | 40 |
| Degree of tack on cured plaque | tacky | no tack | no tack |
| Press Cure @ 330° F. (min) | 45 | 45 | 45 |
| Physicals (Ambient conditions) | | | |
| Tension; ASTM D412 | | | |
| Tensile Strength, lbf/in² | 285 | 330 | 330 |
| Elongation, % | 100 | 115 | 115 |
| Modulus (100%), lbf/in² | 285 | 300 | 300 |

¹Dupont-Dow IP4640 brand
²DiCup 40 KE brand
³SR 350 brand (Sartomer Company)

While the invention has been described and exemplified in sufficient detail to enable those skilled in the art to make and use it, other embodiments, alternatives, and modifications should become readily apparent without departing from the spirit and scope of the invention.

What is claimed is:

1. A method comprising preparing a composition combining a solid elastomer, an organic peroxide initiator, and a metal carboxylate; and curing the composition under open surface molding conditions so as to produce a molded vulcanized elastomer composition with low tack to tack-free surface.

2. The method of claim 1 wherein the solid elastomer is selected from the group consisting of ethylene-propylene diene rubber (EPDM), nitrile rubber (NBR), polychloroprene (CR), hydrogenated NBR (HNBR), styrene-butadiene rubber (SBR), polybutadiene rubber (BR), ethylene-propylene copolymer (EPM), fluoroelastomers (FKM), silicone rubber (MQ, VMQ), acrylic rubber (ACM), Acrylonitrile-butadiene-styrene (ABS), polyethylene (PE), chlorosulfonated polyethylene (CSM), chlorinated polyethylene (CM) (also known as CPE), natural polyisoprene (NR), synthetic polyisoprene (IR), and ethylene-vinyl acetate (EVA).

3. The method of claim 1 wherein the organic peroxide is selected from the group consisting of dialkyl and peroxyketal peroxides.

4. The method of claim 1 wherein the metal of the metal carboxylate is selected from the group consisting of cobalt, zirconium, manganese, zinc, iron, aluminum, and tin.

5. The method of claim 1 wherein the metal carboxylate is a cobalt carboxylate.

6. The method of claim 5 wherein the cobalt carboxylate is a cobalt salt of a C₂ to C₂₀ fatty acid.

7. The method of claim 6 wherein the cobalt carboxylate is selected from the group consisting of cobalt neodecanoate, cobalt proprionate, cobalt naptheneate, and cobalt octoate.

8. The method of claim 1 wherein a cross-linking monomer is combined with the elastomer prior to curing.

9. The method of claim 1 wherein the composition comprises about 0.1 to 10 parts by weight per hundred metal carboxylate.

10. The method of claim 1 wherein the curing conditions are selected from the group consisting of open hot air, open steam, open salt bath, and open sand bath.

11. The method of claim 1 wherein the composition comprises about 0.2 to 5 parts by weight per hundred metal carboxylate.

12. The method of claim 1 wherein the metal carboxylate is selected from the group consisting of metal neodecanoate, metal proprionate, metal naptheneate, and metal octoate.

13. The method of claim 1 wherein the metal carboxylate is dissolved in a crosslinking coagent and the resultant solution and the organic peroxide initiator are blended with the elastomer to form the composition.

14. The method of claim 13 wherein the solution of metal carboxylate in cross-linking coagent comprises about 5 to 25% metal carboxylate

15. The method of claim 13 wherein about 2 to 20 parts by weight of the solution is blended with 100 parts by weight of the elastomer.

16. The method of claim 13 wherein the cobalt carboxylate is cobalt neodecanoate, the cross-linking coagent is trimethylol propane trimethacrylate (TMPTM), the elastomer is EPDM, and the peroxide is dicumyl peroxide.

17. The method of claim 16 wherein the curing is effected with hot air on an open surface.

18. The method of claim 17 wherein the curing is effected with hot air at 130° to 200° C.

19. A cross-linked, vulcanized elastomer having low tack or tack free surface prepared by the open surface curing process of claim 16.

20. An article prepared by the process of claim 16.

21. A vulcanized elastomer prepared by the open surface curing process of claim 1.

22. An article prepared by the open surface molding process of claim 1.

23. A composition comprising solid elastomer, an organic peroxide initiator, and a metal carboxylate, suitable for molding to form articles.
